(19) United States
(12) Patent Application Publication
(10) Pub. No.: US 2019/0193317 A1
(43) Pub. Date: Jun. 27, 2019

(54) TWO SHOT DUAL INJECTED MOLDED LABEL TWO DIMENSIONAL BARCODED POLYPROPYLENE TUBES

(71) Applicant: Scientific Specialties, Incorporated, Lodi, CA (US)

(72) Inventors: Kenneth R. Hovatter, Acampo, CA (US); Anthony McCracken, Lodi, CA (US)

(21) Appl. No.: 15/851,428

(22) Filed: Dec. 21, 2017

(51) Int. Cl. B29C 45/64; B29C 45/00

(52) U.S. Cl. CPC B29C 45/64; B29L 2023/00; B29C 45/0001

(57) ABSTRACT

According to some exemplary embodiments, the present disclosure is directed to exemplary polypropylene tubes and the methods of making such, including, molding a polypropylene tube with a rounded bottom and an opening, moving the molded polypropylene tube to a secondary position, electrostatically attaching a second shot label to a flat cavity surface opposite the rounded bottom of the molded polypropylene tube, injecting polypropylene through an opening in the mold, and forming a flattened surface on top of the rounded bottom, the flattened surface encompassing and displaying an exterior side of the second shot label.

### FIELD OF THE TECHNOLOGY

The present technology relates generally to scientific equipment, and more particularly to polypropylene tubes.

### SUMMARY OF THE PRESENT TECHNOLOGY

According to some exemplary embodiments, the present disclosure is directed to exemplary polypropylene tubes and the methods of making such, including, molding a polypropylene tube with a rounded bottom and an opening, moving the molded polypropylene tube to a secondary position, electrostatically attaching a second shot label to a flat cavity surface opposite the rounded bottom of the molded polypropylene tube, injecting polypropylene through an opening in a mold, and forming a flattened surface on top of the rounded bottom, the flattened surface encompassing and displaying an exterior side of the second shot label.

Further exemplary methods include using a first molded cavity to form the molded polypropylene tube with the rounded bottom with the opening and an optional first shot label inside of the first molded cavity prior to injecting a first shot of polypropylene. Additionally, exemplary methods may include using a second molded cavity to electrostatically mate the rounded bottom of the molded polypropylene tube to an interior side of the second shot label, inject polypropylene through an opening, and form a flattened surface on top of the rounded bottom, the flattened surface encompassing and displaying the exterior side of the second shot label.

In further exemplary methods, a fully rotating interface inserted into the molded polypropylene tube may be used to transfer the molded polypropylene tube with the rounded bottom with the opening from the first molded cavity to the second molded cavity.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 shows an exemplary first molding configuration.

FIG. 2 shows an exemplary first molding configuration with an optional first shot injection molded label.

FIG. 3 shows an exemplary first molding configuration fully engaged for a first injection of polypropylene.

FIG. 4 shows an exemplary first molding configuration disengaged with a separate representation of a molded polypropylene tube as it actually remains on a spinnable mold.

FIG. 5 shows an exemplary second molding configuration with a separate representation of the second shot label un-inserted and as it actually appears inserted on a fixed cavity second shot mold.

FIG. 6 shows an exemplary second molding configuration fully engaged for a second injection of polypropylene.

FIG. 7 shows an exemplary second molding configuration disengaged with a detached representation of the finished two shot dual injected molded label two dimensional barcoded polypropylene tube.

### DETAILED DESCRIPTION

According to some embodiments, the present disclosure provides solutions for generating two shot dual injected molded label two dimensional barcoded polypropylene tubes.

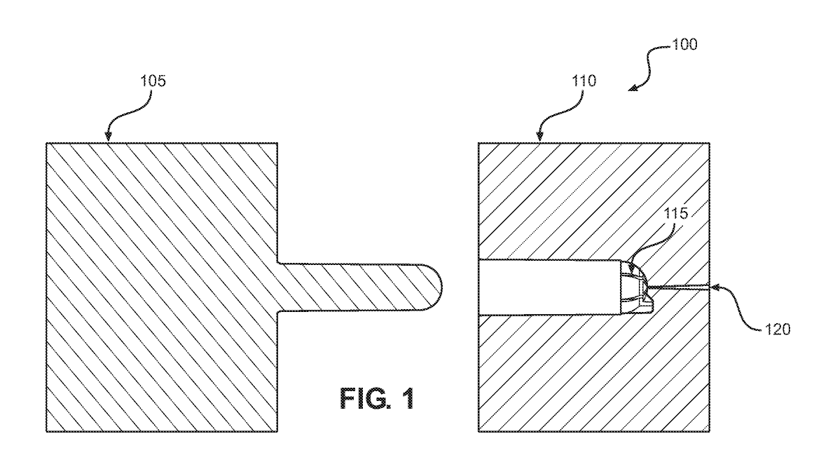

FIG. 1 shows an exemplary first molding configuration.

FIG. 1 shows first molding configuration 100, spinnable mold 105, fixed cavity first shot mold 110, missing leg position 115, and first polypropylene shot gate 120.

Referring to FIG. 1, according to exemplary embodiments, the first molding configuration 100 is in an open position. Spinnable mold 105 is capable of opening and rotating, while fixed cavity first shot mold 110 remains in a fixed position. Notably, fixed cavity first shot mold 110 includes missing leg position 115, which results in the molded polypropylene tube having five of six legs. The missing leg will be used for a second shot of polypropylene later in the process. First polypropylene shot gate 120 is used to inject polypropylene into the first molding configuration 100 when it is engaged in order to form a polypropylene tube.

According to various exemplary embodiments, the molds used herein are constructed of metal. Additionally, various sizes of molds may be constructed in order to manufacture polypropylene tubes that may range in volumes of 0.5 milliliter to 50 milliliters or greater.

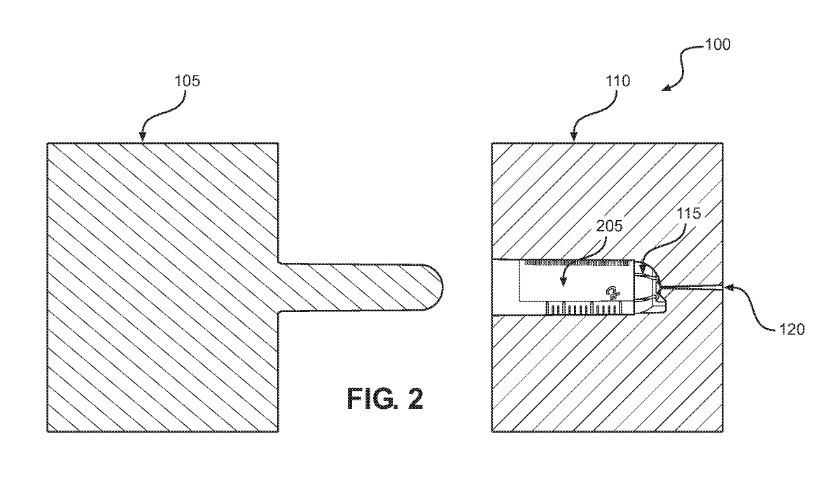

FIG. 2 shows an exemplary first molding configuration with an optional first shot injection molded label.

FIG. 2 shows first molding configuration 100 (FIG. 1), spinnable mold 105 (FIG. 1), fixed cavity first shot mold 110 (FIG. 1), missing leg position 115 (FIG. 1), first polypropylene shot gate 120 (FIG. 1), and optional first shot label 205, which may be a barcode, QR code or other representation.

Turning to FIG. 2, optional first shot label 205 is shown inserted within fixed cavity first shot mold 110. In various exemplary embodiments, optional first shot label 205 is an injected molded label (“IML”) made of polypropylene. A polypropylene tube may be molded with or without the optional first shot label 205.

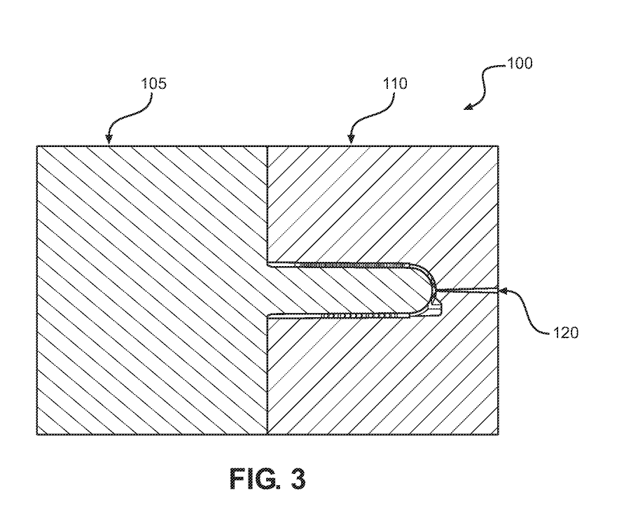

FIG. 3 shows an exemplary first molding configuration fully engaged for a first injection of polypropylene.

FIG. 3 shows first molding configuration 100 (FIG. 1), spinnable mold 105 (FIG. 1), fixed cavity first shot mold 110 (FIG. 1), and first polypropylene shot gate 120 (FIG. 1).

In FIG. 3, according to many exemplary embodiments, spinnable mold 105 has moved in to fully engage with fixed cavity first shot mold 110. Upon doing so, a first shot of polypropylene will be injected through the first polypropylene shot gate 120.

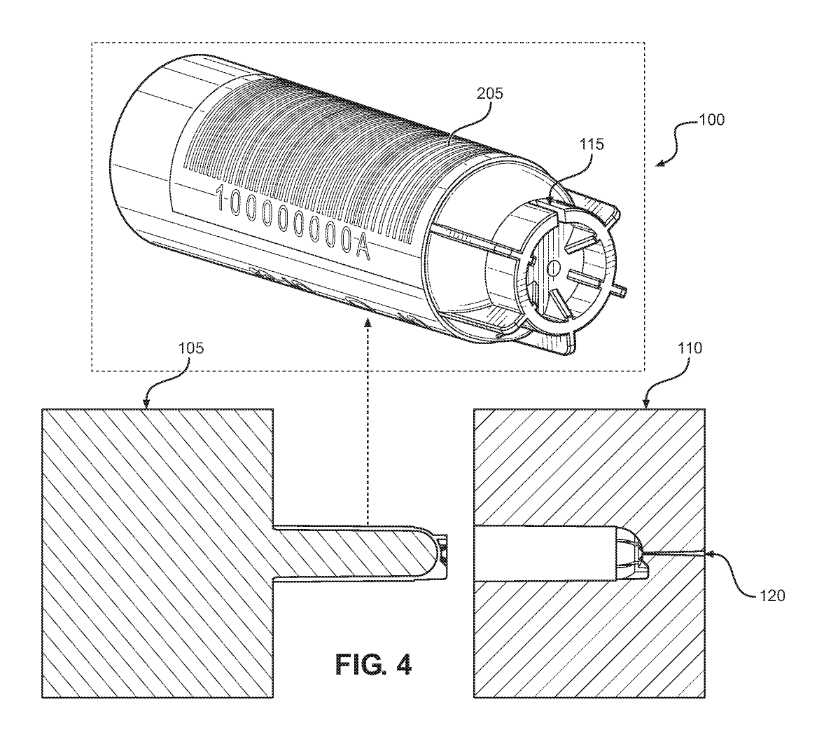

FIG. 4 shows an exemplary first molding configuration disengaged with a separate representation of a molded polypropylene tube as it actually remains on the spinnable mold 105.

FIG. 4 shows first molding configuration 100 (FIG. 1), spinnable mold 105 (FIG. 1), fixed cavity first shot mold 110 (FIG. 1), missing leg position 115 (FIG. 1), first polypropylene shot gate 120 (FIG. 1), and optional first shot label 205 (FIG. 2).

Turning to FIG. 4, although during normal operation the resulting molded polypropylene tube remains on the spinnable mold 105 after disengaging from the fixed cavity first shot mold 110, the separate representation shows (if removed from the spinnable mold 105), after a single shot of polypropylene, a molded polypropylene tube with the optional first shot label 205 permanently attached to the side of the molded polypropylene tube and missing leg 115 (for a future second shot of polypropylene).

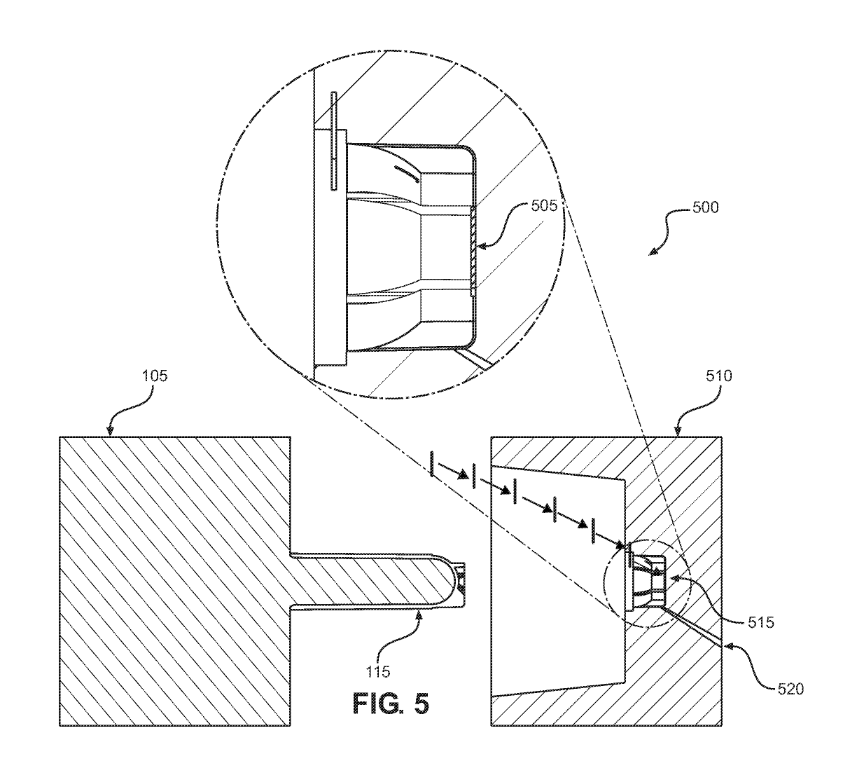

FIG. 5 shows an exemplary second molding configuration with a separate representation of the second shot label un-inserted and as it actually appears inserted on a fixed cavity second shot mold.

FIG. 5 shows second molding configuration 500, spinnable mold 105 (FIG. 1), missing leg position 115 (FIG. 1), second shot label (un-inserted) 505, fixed cavity second shot mold 510, second shot label (inserted) 515, and second polypropylene shot gate 520.

Referring to FIG. 5, in most exemplary embodiments, fixed cavity second shot mold 510 comprises a shallow opening in the mold. The second shot label 505, such as a bar code or a QR code or other representation, may be placed in the fixed cavity second shot mold 510 as illustrated by inserted second shot label 515. Advantageously, this allows for the placement of a bar code or a QR code deep in the bottom of a molded polypropylene tube, regardless of the length of the tube. At the same time, the spinnable mold 105 rotates the molded polypropylene tube with the missing leg position 115 to the bottom, in order to align with second polypropylene shot gate 520 upon engagement.

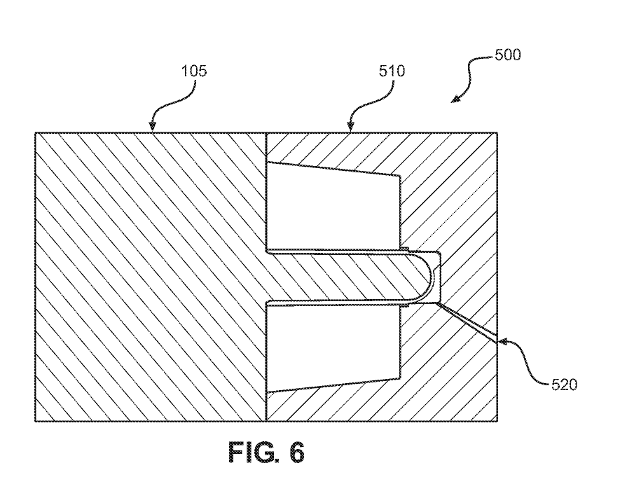

FIG. 6 shows an exemplary second molding configuration fully engaged for a second injection of polypropylene.

FIG. 6 shows second molding configuration 500 (FIG. 5), spinnable mold 105 (FIG. 1), fixed cavity second shot mold 510 (FIG. 5), and second polypropylene shot gate 520 (FIG. 5).

Turning to FIG. 6 (in light of FIG. 5), in most exemplary embodiments, the spinnable mold 105 with the first shot molded polypropylene tube is inserted into the fixed cavity second shot mold 510, so as to have the missing leg position 115 in a position to receive a second shot of polypropylene through second polypropylene shot gate 520. Before receiving the second shot of polypropylene, the inserted second shot label 515 that was electrostatically attached to a flat cavity surface opposite the rounded bottom of the molded polypropylene tube, is brought into close proximity of the rounded bottom of the molded polypropylene tube.

The second shot of polypropylene is injected through the second polypropylene shot gate 520 and forms a flattened surface on top of the rounded bottom, the flattened surface encompassing and displaying an exterior side of the second shot label.

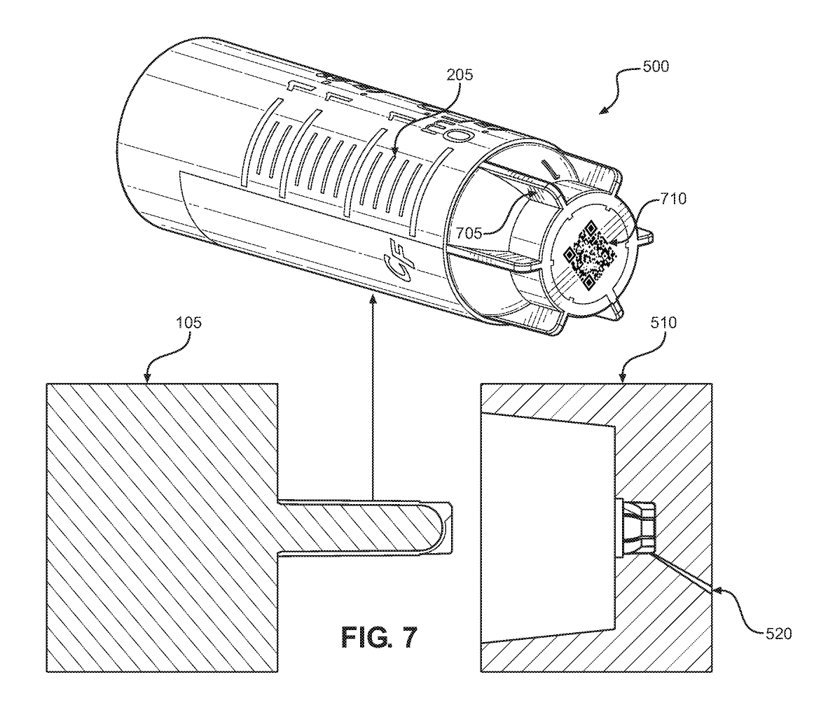

FIG. 7 shows an exemplary second molding configuration disengaged with a detached representation of the finished two shot dual injected molded label two dimensional barcoded polypropylene tube.

FIG. 7 shows second molding configuration 500 (FIG. 5), spinnable mold 105 (FIG. 1), optional first shot label 205 (FIG. 2), fixed cavity second shot mold 510 (FIG. 5), second polypropylene shot gate 520 (FIG. 5), new leg 705 and second shot label 710.

Referring to FIG. 7, in most exemplary embodiments, the finished two shot dual injected molded label two dimensional barcoded polypropylene tube is of unitary construction with the new leg 705, the optional first shot label 205 and second shot label 710 forming an integrated unit of the molded polypropylene tube. Additionally, the finished two shot dual injected molded label two dimensional barcoded polypropylene tube is manufactured in a single operation, with the spinnable mold 105 moving (rotating) between the fixed cavity first shot mold 110 and the fixed cavity second shot mold 510.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for making a polypropylene tube, the method comprising:
molding a polypropylene tube with a rounded bottom and an opening;
moving the molded polypropylene tube to a secondary position;
electrostatically attaching a second shot label to a flat cavity surface opposite the rounded bottom of the molded polypropylene tube;
injecting polypropylene through an opening; and forming a flattened surface on top of the rounded bottom, the flattened surface encompassing and displaying an exterior side of the second shot label.

2. The method of claim 1, further comprising using a first molded cavity to form the molded polypropylene tube with the rounded bottom and the opening.

3. The method of claim 2, further comprising inserting an optional first shot label inside of the first molded cavity prior to injecting polypropylene.

4. The method of claim 3, further comprising using a second molded cavity to electrostatically mate the rounded bottom of the molded polypropylene tube to an interior side of the second shot label, inject polypropylene through an opening, and form a flattened surface on top of the rounded bottom, the flattened surface encompassing and displaying the exterior side of the second shot label.

5. The method of claim 4, further comprising using a fully rotating interface inserted into the molded polypropylene tube to transfer the molded polypropylene tube with the rounded bottom with the opening from the first molded cavity to the second molded cavity.
